(19) United States
(12) Patent Application Publication
(10) Pub. No.: US 2026/0004385 A1
(43) Pub. Date: Jan. 1, 2026

(54) IMAGE PROCESSING CIRCUIT AND OPERATION METHOD THEREOF

(71) Applicant: Sigmastar Technology Ltd., Xiamen (CN)

(72) Inventors: Fu-Cheng CHEN, Hsinchu County (TW); Wen-Nan HUANG, Hsinchu County (TW)

(21) Appl. No.: 19/221,970

(22) Filed: May 29, 2025

(30) Foreign Application Priority Data
Jun. 27, 2024 (CN) 202410851331.X

(51) Int. Cl. G06T 1/60

(52) U.S. Cl. CPC G06T 1/60

(57) ABSTRACT

An image processing circuit is coupled to an image sensor and includes a first memory, a second memory, an image receiving circuit, and a memory access circuit. The image receiving circuit is configured to receive an image from the image sensor and store the image in the first memory. The memory access circuit is configured to write the image from the first memory into the second memory. When the image receiving circuit stores the image in the first memory, the image processing circuit operates in a low-speed mode, and when the memory access circuit writes the image from the first memory into the second memory, the image processing circuit operates in a high-speed mode. The first operating speed of the second memory in the low-speed mode is lower than the second operating speed of the second memory in the high-speed mode.

This application claims the benefit of China application Serial No. CN202410851331.X, filed on Jun. 27, 2024, the subject matter of which is incorporated herein by reference.

### BACKGROUND OF THE INVENTION

### 1. Field of the Invention

The present invention generally relates to image processing, and more particularly, to an image processing circuit and its operation method.

### 2. Description of Related Art

Reference is made to FIG. 1, which is a functional block diagram of a conventional electronic device. The electronic device 100 includes an image processing circuit 110 and an image sensor 120. The image processing circuit 110 is coupled to the image sensor 120 and includes a processor 111, a first memory 112, an image receiving circuit 113, and a second memory 114.

The image sensor 120 captures an image through a lens and generates an image IMG. The image receiving circuit 113 processes (e.g., cropping) the image IMG and then writes the image IMG into the second memory 114. Afterward, the image processing circuit 110 reads the image IMG from the second memory 114 and performs subsequent processing on the image IMG.

However, because the second memory 114 remains in an active state while the image receiving circuit 113 writes the image IMG into the second memory 114, the second memory 114 consumes excessive power, leading to a decline in the user experience of the electronic device 100.

### SUMMARY OF THE INVENTION

In view of the issues of the prior art, an object of the present invention is to provide an image processing circuit and its operation method, so as to make an improvement to the prior art.

According to one aspect of the present invention, an image processing circuit is provided. The image processing circuit includes: a first memory; a second memory; an image receiving circuit coupled to the image sensor and the first memory and configured to receive an image from the image sensor and store the image in the first memory; and a memory access circuit coupled to the first memory and the second memory and configured to write the image from the first memory into the second memory. When the image receiving circuit stores the image in the first memory, the image processing circuit operates in a low-speed mode, and when the memory access circuit writes the image from the first memory into the second memory, the image processing circuit operates in a high-speed mode. The first operating speed of the second memory in the low-speed mode is lower than the second operating speed of the second memory in the high-speed mode.

According to another aspect of the present invention, a method of operating an image processing circuit is provided. The image processing circuit is coupled to an image sensor and includes a first memory and a second memory. The method includes the following steps: in a low-speed mode, receiving an image from the image sensor and storing the image in the first memory; and in a high-speed mode, writing the image from the first memory into the second memory. The first operating speed of the second memory in the low-speed mode is lower than the second operating speed of the second memory in the high-speed mode.

According to still another aspect of the present invention, an image processing circuit is provided. The image processing circuit is coupled to an image sensor and an external memory and includes: a memory; an image receiving circuit coupled to the image sensor and the memory and configured to receive an image from the image sensor and store the image in the memory; and a memory access circuit coupled to the memory and the external memory and configured to write the image from the memory into the external memory. When the image receiving circuit stores the image in the memory, the image processing circuit operates in a low-speed mode, and when the memory access circuit writes the image from the memory into the external memory, the image processing circuit operates in a high-speed mode. The first operating speed of the external memory in the low-speed mode is lower than the second operating speed of the external memory in the high-speed mode.

The technical means embodied in the embodiments of the present invention can solve at least one of the problems of the prior art. Therefore, compared to the prior art, the present invention can save power.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of a conventional electronic device.

FIG. 2 is a functional block diagram of the electronic device according to an embodiment of the present invention.

FIG. 3 is a schematic diagram of the image transmission according to an embodiment of the present invention.

FIGS. 4A to 4B are flowcharts of the operation method of the image processing circuit according to an embodiment of the present invention.

FIG. 5 is a functional block diagram of the electronic device according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an image processing circuit and its operation method. On account of that some or all elements of the image processing circuit could be known, the detail of such elements is omitted provided that such detail has little to do with the features of this disclosure, and that this omission nowhere dissatisfies the specification and enablement requirements. Some or all of the processes of the operation method of the image processing circuit may be implemented by software and/or firmware and can be performed by the image processing circuit or its equivalent. A person having ordinary skill in the art can choose components or steps equivalent to those described in this specification to carry out the present invention, which means that the scope of this invention is not limited to the embodiments in the specification.

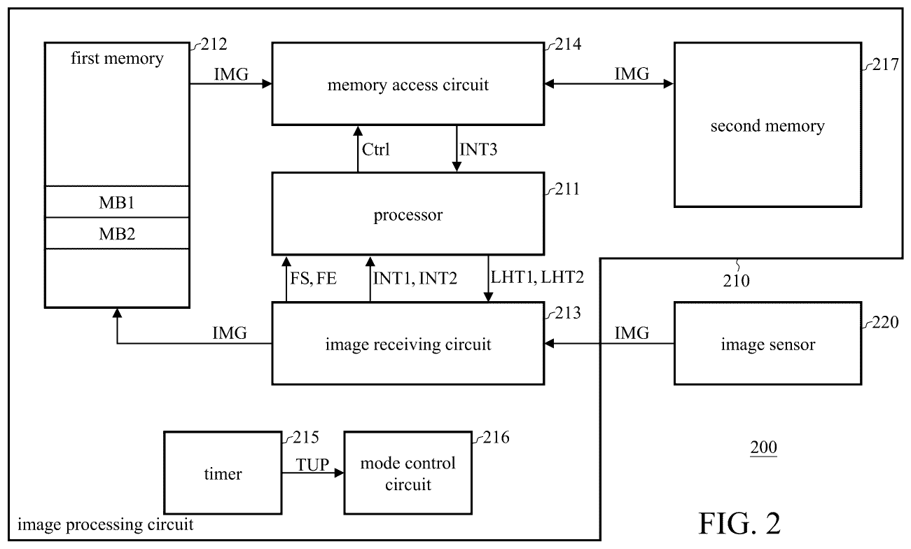

Reference is made to FIG. 2, which is a functional block diagram of the electronic device according to an embodiment of the present invention. The electronic device 200 includes an image processing circuit 210 and an image sensor 220. The image processing circuit 210 includes a processor 211, a first memory 212, an image receiving circuit 213, a memory access circuit 214, a timer 215, a mode control circuit 216, and a second memory 217.

The first memory 212 and the second memory 217 are different hardware. The operating frequency of the first memory 212 may not be equal to the operating frequency of the second memory 217. In some embodiments, the first memory 212 may be a Static Random Access Memory (SRAM), and the second memory 217 may be a Pseudo-Static Random Access Memory (PSRAM).

The function of the image sensor 220 is similar to the function of the image sensor 120. In some embodiments, the image sensor 220 includes a photosensitive element, a Serial Peripheral Interface (SPI), and a power circuit.

The image receiving circuit 213 is coupled to the image sensor 220. After the image receiving circuit 213 receives the image IMG from the image sensor 220, the image receiving circuit 213 stores the image IMG line by line into the memory block MB1 or the memory block MB2 of the first memory 212. Afterward, the memory access circuit 214 reads the image IMG from the first memory 212 and stores the image IMG into the second memory 217.

The image receiving circuit 213 transmits the image start signal FS and the image end signal FE to the processor 211. The image start signal FS indicates the start of the image IMG, and the image end signal FE indicates the end of the image IMG.

The processor 211 sets the image receiving circuit 213 with the threshold value LHT1 and the threshold value LHT2. The image receiving circuit 213 generates an interrupt INT1 (or INT2) based on the data amount of the image IMG that has been currently processed and the threshold value LHT1 (or LHT2). In response to the interrupt INT1 or the interrupt INT2, the processor 211 uses the control signal Ctrl to control the memory access circuit 214 to start transferring the image IMG.

The processor 211 may be a circuit or electronic component with program execution capability, such as a central processing unit (CPU), a microprocessor, a micro-processing unit, a digital signal processor (DSP), an application specific integrated circuit (ASIC), or an equivalent circuit.

The memory access circuit 214 reads partial data of the image IMG (e.g., an image block) from the first memory 212 (more specifically, the memory block MB1 or the memory block MB2), and after writing the partial data into the second memory 217, issues an interrupt INT3 to notify the processor 211.

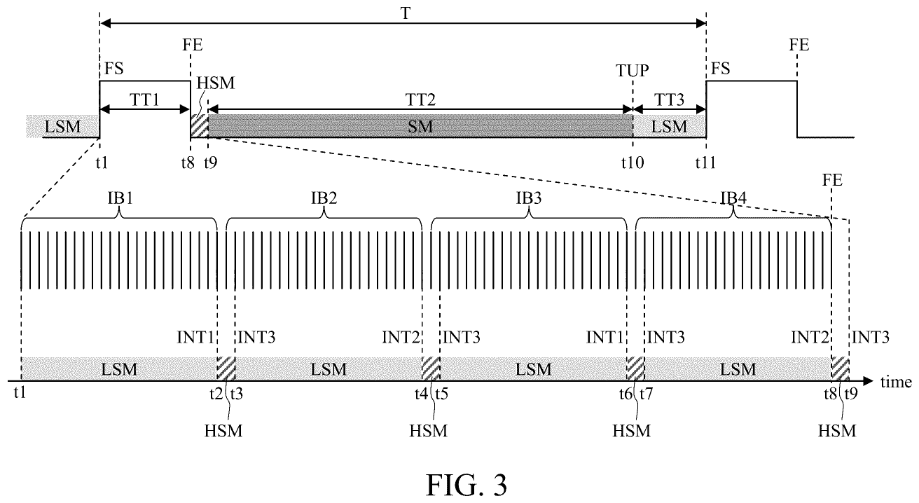

Reference is made to FIG. 3, which is a schematic diagram of image transmission according to an embodiment of the present invention. The image sensor 220 transmits an image IMG every cycle T. The data of the image IMG occupies the duration TT1 of the cycle T, and the remaining time of the cycle T (i.e., T−TT1) is the vertical blank interval (VBI) of the image.

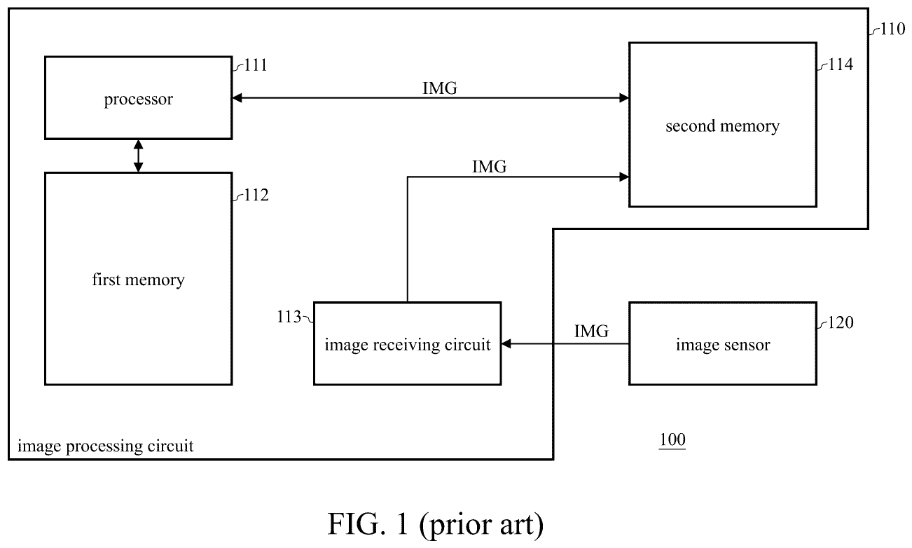

For the electronic device 100 in FIG. 1, between the image start signal FS and the image end signal FE (i.e., during the entire duration TT1), the second memory 114 remains in a high-power consumption operating state (i.e., corresponding to the high-speed mode HSM in FIG. 3).

Reference is made to FIG. 2 and FIG. 3. In the present invention, an image IMG is divided into N image blocks for transmission, and each image block includes multiple image lines. Whenever the image receiving circuit 213 completes storing an image block into the memory block MB1 (or MB2), the image receiving circuit 213 issues an interrupt INT1 (or INT2). Whenever the memory access circuit 214 completes moving an image block from the first memory 212 to the second memory 217, the memory access circuit 214 issues an interrupt INT3. In the example of FIG. 3, N equals 4.

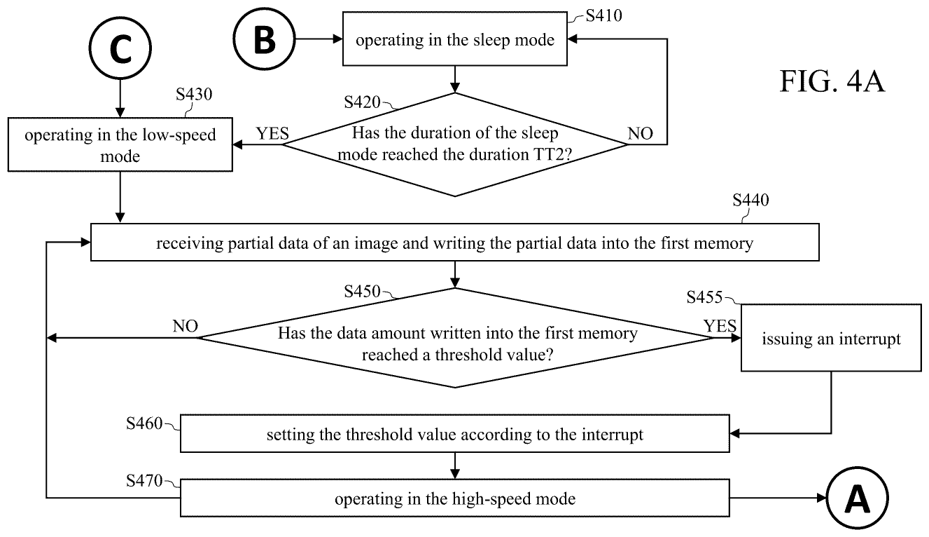

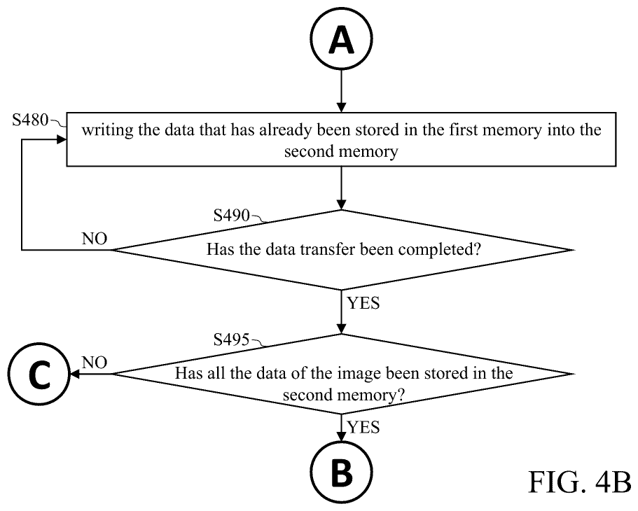

Reference is made to FIGS. 4A to 4B, which are flowcharts of an operation method of an image processing circuit according to an embodiment of the present invention. The operation method includes the following steps.

Step S410: The image processing circuit 210 operates in the sleep mode SM. The operation mode of the image processing circuit 210 is controlled by the mode control circuit 216. In the sleep mode SM, the mode control circuit 216 reduces the clock frequencies of the processor 211, the first memory 212, the image receiving circuit 213, the memory access circuit 214, and the second memory 217 to reduce the overall power consumption of the image processing circuit 210. In the sleep mode SM, the second memory 217 enters the retention state. When the sleep mode SM starts (e.g., at time point t9 in FIG. 3), the timer 215 begins timing the duration TT2. Once the duration TT2 ends (e.g., at time point t10 in FIG. 3), the timer 215 issues the timing end signal TUP. In response to the timing end signal TUP, the mode control circuit 216 controls the image processing circuit 210 to exit the sleep mode SM. When the image processing circuit 210 exits the sleep mode SM, the second memory 217 exits the retention state.

Step S420: The mode control circuit 216 determines whether the duration of the sleep mode SM has reached the duration TT2 according to the timing end signal TUP. In the example of FIG. 3, the image processing circuit 210 enters the sleep mode SM at time point t9; after the duration TT2, the timer 215 issues the timing end signal TUP at time point t10. Before the mode control circuit 216 receives the timing end signal TUP (step S420 is NO), the mode control circuit 216 controls the image processing circuit 210 to continue operating in the sleep mode SM (step S410). When the mode control circuit 216 receives the timing end signal TUP (step S420 is YES), the mode control circuit 216 controls the image processing circuit 210 to operate in the low-speed mode LSM (step S430).

Step S430: The mode control circuit 216 controls the image processing circuit 210 to operate in the low-speed mode LSM. During the transition process from the sleep mode SM to the low-speed mode LSM, the mode control circuit 216 increases the clock frequencies of the processor 211, the first memory 212, the image receiving circuit 213, the memory access circuit 214, and the second memory 217. More specifically, the processor 211, the first memory 212, the image receiving circuit 213, the memory access circuit 214, and the second memory 217 operate at frequencies higher in the low-speed mode LSM than in the sleep mode SM. The duration TT3 is the interval between the timing end signal TUP and the image start signal FS. The duration TT3 can be adjusted by setting the timer 215 (the shorter the duration TT2, the longer the duration TT3; the longer the duration TT2, the shorter the duration TT3). The length of the duration TT3 must be sufficient to allow the above-mentioned components to operate stably in the low-speed mode LSM (e.g., sufficient to allow the above-mentioned components to complete initialization to exit the sleep mode SM). In the low-speed mode LSM, the processor 211 operates in the wait for interrupt (WFI) state.

Step S440: The image receiving circuit 213 receives partial data of the image IMG and writes the partial data into the first memory 212. Reference is made to FIG. 3. The image receiving circuit 213 receives the image IMG line by line (from the image block IB1 to the image block IB4) and writes the image IMG line by line into the memory block MB1 or the memory block MB2. In some embodiments, the image receiving circuit 213 writes the odd-numbered image blocks (IB1, IB3) into the memory block MB1, and writes the even-numbered image blocks (IB2, IB4) into the memory block MB2.

Step S450: The image receiving circuit 213 determines whether the data amount written into the first memory 212 (e.g., the number of lines) has reached a threshold value. When the data amount written into the first memory 212 equals the threshold value (e.g., when an entire image block has been written), the flow proceeds to step S455; otherwise, the flow proceeds to step S440.

Step S455: The image receiving circuit 213 issues an interrupt to the processor 211. For example, whenever the image receiving circuit 213 finishes writing an image block into the first memory 212, the image receiving circuit 213 issues an interrupt. In some embodiments, when the data amount (e.g., the number of lines) written into the memory block MB1 (or MB2) is equal to the threshold value LHT1 (or LHT2), the image receiving circuit 213 issues an interrupt INT1 (or INT2) (e.g., at time points t2, t4, t6, or t8 in FIG. 3).

Step S460: The processor 211 sets the threshold value according to the interrupt. More specifically, at this step the processor 211 sets the threshold value LHT1 according to the interrupt INT1 (e.g., at time points t2 and t6), or sets the threshold value LHT2 according to the interrupt INT2 (e.g., at time points t4 and t8). This step will be detailed below with reference to FIG. 3.

Step S470: The processor 211 instructs the mode control circuit 216 to control the image processing circuit 210 to operate in the high-speed mode HSM. During the transition process from the low-speed mode LSM to the high-speed mode HSM, the mode control circuit 216 increases the clock frequencies of the processor 211, the first memory 212, the image receiving circuit 213, the memory access circuit 214, and the second memory 217. More specifically, the processor 211, the first memory 212, the image receiving circuit 213, the memory access circuit 214, and the second memory 217 operate at frequencies higher in the high-speed mode HSM than in the low-speed mode LSM. After the image processing circuit 210 enters the high-speed mode HSM, on one hand, the image receiving circuit 213 writes partial data of the image IMG (e.g., part of the image block IB2) into a memory block (e.g., MB2) in the first memory 212 (step S440), and on the other hand, the memory access circuit 214 writes the data (e.g., the image block IB1) that has previously been stored in another memory block (e.g., MB1) into the second memory 217 (step S480).

Step S490: The memory access circuit 214 determines whether the data transfer of the previous memory block has been completed. If YES (e.g., the image block IB1 has been completely written into the second memory 217), then the memory access circuit 214 issues an interrupt INT3, and then the flow proceeds to step S495; otherwise, the flow returns to step S480 to continue transferring the data.

Step S495: The processor 211 determines whether all the data of the image IMG has been stored in the second memory 217. More specifically, according to the image end signal FE from the image receiving circuit 213 and the interrupt INT3 from the memory access circuit 214, the processor 211 can determine that an image IMG has been completely stored in the second memory 217 (step S495 is YES) (e.g., at time point t9, which is the first interrupt INT3 after the image end signal FE). If step S495 is YES, then the processor 211 instructs the mode control circuit 216 to control the image processing circuit 210 to operate in the sleep mode SM (step S410), and instructs the timer 215 to start timing; otherwise, the processor 211 instructs the mode control circuit 216 to control the image processing circuit 210 to operate in the low-speed mode LSM (step S430).

The following details the process of FIG. 4A to FIG. 4B using FIG. 3 as an example. Assuming that an image IMG has a size of 640×360, then an image block IB1, an image block IB2, an image block IB3, and an image block IB4 can each contain 90 (=360/4) lines. The initial values of the threshold value LHT1 and the threshold value LHT2 can be 90 (i.e., the data amount of the image block IB1) and 180 (i.e., the total data amount of the image blocks IB1 and IB2), respectively.

At time point t1, the image IMG starts (the image receiving circuit 213 sends an image start signal FS to the processor 211), and at this time the image processing circuit 210 operates in the low-speed mode LSM (step S430).

Between time point t1 and time point t2, the image processing circuit 210 operates in the low-speed mode LSM, and the image receiving circuit 213 continues to perform step S440 to gradually store the image block IB1 into the memory block MB1.

At time point t2, the image block IB1 has been completely stored in the memory block MB1 (i.e., the data amount written into the first memory 212 reaches the threshold value LHT1), and the image receiving circuit 213 issues an interrupt INT1 (step S455). Then, the processor 211 sets the threshold value LHT1 to 270 (i.e., the total data amount of the image blocks IB1, IB2, and IB3) according to the interrupt INT1 (step S460).

Between time point t2 and time point t3, the image processing circuit 210 operates in the high-speed mode HSM (step S470), the image receiving circuit 213 writes the image block IB2 into the memory block MB2 (step S440), and the memory access circuit 214 transfers the image block IB1 from the memory block MB1 to the second memory 217 (step S480).

At time point t3, the memory access circuit 214 completes the transfer of the image block IB1 (step S490 is YES), and issues the interrupt INT3. It should be noted that, because at this time all the data of the image IMG has not yet been stored in the second memory 217, the result of step S495 is NO.

Between time point t3 and time point t4, the image processing circuit 210 operates in the low-speed mode LSM (step S430), and the image receiving circuit 213 continues to gradually write the image block IB2 into the memory block MB2 (step S440).

At time point t4, the image block IB2 has been completely stored in the memory block MB2 (i.e., the data amount written into the first memory 212 reaches the threshold value LHT2), and the image receiving circuit 213 issues an interrupt INT2 (step S455). Then, the processor 211 sets the threshold value LHT2 to 360 (i.e., the total data amount of the image IMG) according to the interrupt INT2 (step S460).

Between time point t4 and time point t5, the image processing circuit 210 operates in the high-speed mode HSM (step S470), the image receiving circuit 213 writes the image block IB3 into the memory block MB1 (step S440), and the memory access circuit 214 transfers the image block IB2 from the memory block MB2 to the second memory 217 (step S480).

At time point t5, the memory access circuit 214 completes the transfer of the image block IB2 (step S490 is YES) and issues the interrupt INT3. It should be noted that, because at this time all the data of the image IMG has not yet been stored in the second memory 217, the result of step S495 is NO.

The operation at time point t6 is similar to the operation at time point t2, but the image block in the operation is the image block IB3, and the threshold value LHT1 is reset to 90.

The operation at time point t7 is similar to the operation at time point t3, but the image blocks in the operation are the image block IB3 and the image block IB4.

The operation at time point t8 is similar to the operation at time point t4, but the image block in the operation is the image block IB4, and the threshold value LHT2 is reset to 180.

At time point t9, the memory access circuit 214 completes the transfer of the image block IB4 (step S490 is YES). Because at this time the entire image IMG has already been stored in the second memory 217 (step S495 is YES), the mode control circuit 216 controls the image processing circuit 210 to operate in the sleep mode SM (step S410).

Between time point t9 and time point t10, the image processing circuit 210 operates in the sleep mode SM (step S420 is NO).

At time point t10, the timer 215 generates the timing end signal TUP (step S420 is YES), and according to the timing end signal TUP, the mode control circuit 216 controls the image processing circuit 210 to operate in the low-speed mode LSM (step S430).

At time point t11, the image receiving circuit 213 starts receiving the next image IMG from the image sensor 220.

In some embodiments, the operating speed of the first memory 212 in the low-speed mode LSM is related to the speed at which the image receiving circuit 213 receives the image IMG from the image sensor 220. For example, the operating speed of the first memory 212 in the low-speed mode LSM is the lowest speed at which the image receiving circuit 213 is sufficient to receive a complete image IMG. In other words, when the image receiving circuit 213 writes the image IMG into the first memory 212 at the lowest speed, no data of the image IMG will be lost.

In some embodiments, the mode control circuit 216 can be implemented as a finite-state machine (FSM) based on the flow of FIGS. 4A to 4B and the embodiment of FIG. 3. The mode control circuit 216 can control the clock frequencies by means of the clock gating technology.

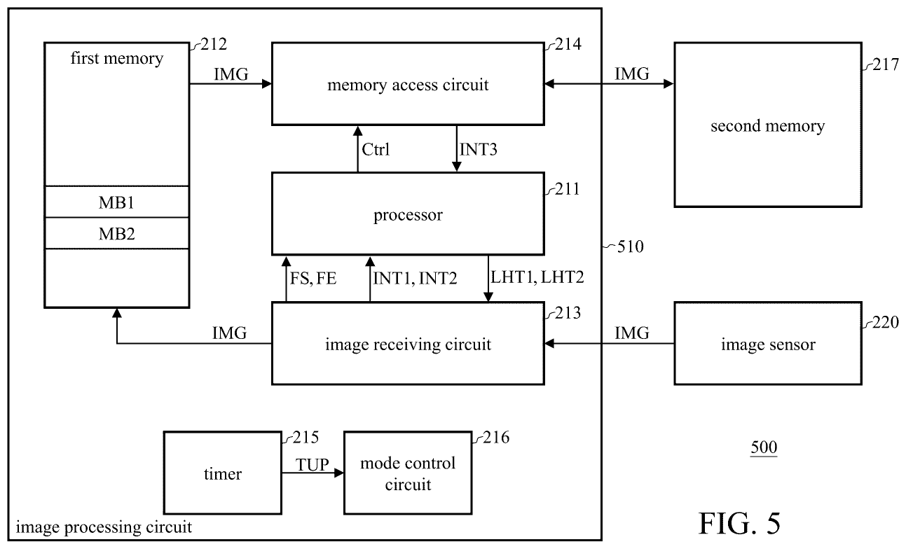

In some embodiments (see FIG. 5), the electronic device 500 includes an image processing circuit 510, a second memory 217, and an image sensor 220, wherein the second memory 217 is disposed outside the image processing circuit 510 (i.e., the second memory 217 is the external memory of the image processing circuit 510). In detail, the second memory 217 and the image processing circuit 510 can be formed on different dies, respectively. However, in this embodiment, the operation modes between the second memory 217 and the image processing circuit 510 can be the same as those in the aforementioned embodiments. That is to say, when the image processing circuit 510 operates in the low-speed mode LSM, the second memory 217 also operates in the low-speed mode LSM; when the image processing circuit 510 operates in the high-speed mode HSM, the second memory 217 also operates in the high-speed mode HSM.

In summary, during the process in which the image processing circuit 210 stores an image IMG into the second memory 217 (e.g., between time point t1 and time point t9 in FIG. 3), since the image processing circuit 210 operates in the low-speed mode LSM for most of the time, the image processing circuit 210 consumes less power compared to the conventional image processing circuit 110 (for comparison, the conventional image processing circuit 110 is in a high-power consumption state between time point t1 and time point t8). In addition, because the image processing circuit 210 operates in the sleep mode SM during the VBI (Vertical Blank Interval) of the image IMG, the image processing circuit 210 can further save power.

In the aforementioned embodiment, the sizes of the image blocks are equal, but this is not a limitation of the present invention. People having ordinary skill in the art can appropriately apply the present invention to image blocks of different sizes according to the disclosure of the present invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An image processing circuit coupled to an image sensor, the image processing circuit comprising:
a first memory;
a second memory;
an image receiving circuit coupled to the image sensor and the first memory and configured to receive an image from the image sensor and store the image in the first memory; and
a memory access circuit coupled to the first memory and the second memory and configured to write the image from the first memory into the second memory;
wherein when the image receiving circuit stores the image in the first memory, the image processing circuit operates in a low-speed mode, and when the memory access circuit writes the image from the first memory into the second memory, the image processing circuit operates in a high-speed mode;
wherein a first operating speed of the second memory in the low-speed mode is lower than a second operating speed of the second memory in the high-speed mode.

2. The image processing circuit of claim 1, further comprising:
a mode control circuit configured to control the image processing circuit to operate in a sleep mode during a portion of a vertical blank interval of the image;
wherein a third operating speed of the second memory in the sleep mode is lower than the first operating speed of the second memory in the low-speed mode.

3. The image processing circuit of claim 2, further comprising:
a timer coupled to the mode control circuit and configured to time a duration and issue a timing end signal when the duration is reached;
wherein the mode control circuit controls the image processing circuit to exit the sleep mode according to the timing end signal.

4. The image processing circuit of claim 3, wherein when the image is completely written into the second memory, the mode control circuit controls the image processing circuit to operate in the sleep mode, and the timer starts to time the duration.

5. The image processing circuit of claim 3, wherein after the duration ends, the mode control circuit controls the image processing circuit to operate in the low-speed mode.

6. The image processing circuit of claim 1, wherein the image comprises a first image block and a second image block, and when the image receiving circuit is storing the second image block into the first memory, the memory access circuit is writing the first image block from the first memory into the second memory.

7. The image processing circuit of claim 1, wherein a third operating speed of the first memory in the low-speed mode is lower than a fourth operating speed of the first memory in the high-speed mode, and the third operating speed is the minimum speed sufficient for completely receiving the image.

8. The image processing circuit of claim 1, further comprising:
a processor coupled to the image receiving circuit and the memory access circuit;
wherein when a data amount written by the image receiving circuit into the first memory reaches a threshold value, the image receiving circuit issues an interrupt, and the processor sets the threshold value according to the interrupt.

9. The image processing circuit of claim 8, wherein the threshold value is a first threshold value, the interrupt is a first interrupt, and the data amount is a first data amount, when a second data amount written by the image receiving circuit into the first memory reaches a second threshold value, the image receiving circuit issues a second interrupt, and the processor sets the second threshold value according to the second interrupt.

10. The image processing circuit of claim 1, wherein the first memory is a Static Random Access Memory (SRAM), and the second memory is a Pseudo-Static Random Access Memory (PSRAM).

11. A method of operating an image processing circuit coupled to an image sensor and comprising a first memory and a second memory, the method comprising:
in a low-speed mode, receiving an image from the image sensor and storing the image in the first memory; and
in a high-speed mode, writing the image from the first memory into the second memory;
wherein a first operating speed of the second memory in the low-speed mode is lower than a second operating speed of the second memory in the high-speed mode.

12. The method of claim 11, further comprising:
during a portion of a vertical blank interval of the image, controlling the image processing circuit to operate in a sleep mode;
wherein a third operating speed of the second memory in the sleep mode is lower than the first operating speed of the second memory in the low-speed mode.

13. The method of claim 12, further comprising:
timing a duration and issuing a timing end signal after the duration is reached; and
controlling the image processing circuit to exit the sleep mode according to the timing end signal.

14. The method of claim 13, further comprising:
controlling the image processing circuit to operate in the sleep mode and starting to time the duration when the image is completely written into the second memory.

15. The method of claim 13, further comprising:
controlling the image processing circuit to operate in the low-speed mode after the duration ends.

16. The method of claim 11, wherein the image comprises a first image block and a second image block, and when the second image block is being stored in the first memory, the first image block is being written from the first memory to the second memory.

17. The method of claim 11, wherein a third operating speed of the first memory in the low-speed mode is lower than a fourth operating speed of the first memory in the high-speed mode, and the third operating speed is the minimum speed sufficient for completely receiving the image.

18. The method of claim 11, further comprising:
issuing an interrupt and setting a threshold value according to the interrupt when a data amount written into the first memory reaches the threshold value.

19. The method of claim 18, wherein the threshold value is a first threshold value, the interrupt is a first interrupt, the data amount is a first data amount, and the method further comprises:
issuing a second interrupt and setting a second threshold value according to the second interrupt when a second data amount written to the first memory reaches the second threshold value.

20. An image processing circuit coupled to an image sensor and an external memory, the image processing circuit comprising:
a memory;
an image receiving circuit coupled to the image sensor and the memory and configured to receive an image from the image sensor and store the image in the memory; and
a memory access circuit coupled to the memory and the external memory and configured to write the image from the memory into the external memory;
wherein when the image receiving circuit stores the image into the memory, the image processing circuit operates in a low-speed mode, and when the memory access circuit writes the image from the memory into the external memory, the image processing circuit operates in a high-speed mode;
wherein a first operating speed of the external memory in the low-speed mode is lower than a second operating speed of the external memory in the high-speed mode.
